(19) United States
(12) Patent Application Publication
(10) Pub. No.: US 2007/0257481 A1
(43) Pub. Date: Nov. 8, 2007

(54) Value Document

(76) Inventors: Gerhard Schwenk, Puchheim (DE); Thomas Giering, Kirchseeon (DE); Gerhard Stenzel, Munchen (DE); Wittich Kaule, Emmering (DE)

Correspondence Address: BACON & THOMAS, PLLC, 625 SLATERS LANE, FOURTH FLOOR, ALEXANDRIA, VA, 22314, US

(21) Appl. No.: 10/575,074

(22) PCT Filed: Oct. 5, 2004
(86) PCT No.: PCT/EP04/11130

§ 371 Date: Mar. 13, 2007

(51) Int. Cl. B42D 15/00

(52) U.S. Cl. 283/72

(57) ABSTRACT

This invention relates to a value document, in particular a bank note, having a value document substrate and at least two different feature substances for checking the value document. According to the invention, a first feature substance is incorporated into the volume of the substrate of the value document, and a second feature substance applied to the value document substrate in the form of a coding.

This invention relates to a value document, in particular a bank note, having a value document substrate and at least two different feature substances for checking the value document.

The print WO 97/39428 discloses a value document whose substrate has, in one area, different machine authenticatable authenticity features for different security levels. The value document contains a machine authenticatable low security feature which is formed from a single material. Upon an interrogation the low security feature provides a yes/no response indicating the presence or absence of the interrogated property. The low security feature is used for authenticity checking in applications where a simple detector is used, for example retail outlets.

A further, likewise machine authenticatable high security feature has properties that are difficult to detect allowing an in-depth interrogation of the value document and a much higher level of authentication. The check of the high security feature is elaborate and effected for example in central banks. Said high security feature is a homogeneous mixture of two substances with different physical properties, such as the excitation wavelength for a luminescence emission or coercivity, etc.

The system known from WO 97/39428 has the disadvantage, however, of permitting an elaborate authenticity check of the value documents but not allowing any statement about the type or value of the particular value document. For machine processing of value documents, in particular of bank notes, it is also desirable to detect by machine the type of document, e.g. the currency or the denomination of a known currency.

On these premises the invention is based on the problem of proposing a generic value document that involves not only increased falsification security but at the same time also a possibility of value recognition.

Value recognition is understood in the context of the present invention to mean the evaluation of information present in coded form for a certain user group. The coded information can be, in the case of a bank note, for example the denomination, the currency, the series, the issuing country or other special features of the bank note.

The problem posed is solved by the value document having the features of the main claim. A production method for such value documents as well as two methods for checking or processing such value documents are the subject matter of the coordinated claims. Advantageous developments of the invention are the subject matter of the subclaims.

The inventive value document has a first feature substance incorporated into the volume of the value document substrate, and a second feature substance applied to the value document substrate in the form of a coding. As explained in detail hereinafter, this combination creates a complex feature system that is very difficult to imitate for a forger. The feature system permits users from different user groups to each carry out both an authenticity check and value recognition on the document.

For example, users of one user group can use a characteristic property of the first feature substance for the authenticity check, while users of another user group employ a characteristic property of the second feature substance for the authenticity check. Both user groups can use the coding formed by the second feature substance for value recognition to be able to carry out not only the authenticity check but also value recognition on the document without any great additional effort. The exact implementation of the authenticity check and the value recognition will be described in detail below.

Said user groups may be central banks, commercial banks, any commercial enterprises such as local train services, department stores or vending machine operators, etc.

Analysis of the total feature system is exceptionally difficult and elaborate, since it is not recognizable to third parties which substances and in particular which substance properties are used for the check by the different user groups. Even knowledge of the procedure of one user group does not readily indicate the substances and methods used for the authenticity check and value recognition by the other user group or groups.

The first feature substance can fundamentally be incorporated into the volume of the value document substrate in any distribution or form a given orderly structure. According to a preferred embodiment of the invention, the first feature substance is distributed substantially uniformly within the volume of the value document substrate, however, so that sufficiently large volume elements of equal size each contain a substantially equal quantity of the first feature substance. The distribution can be regular, but also be effected in a given regular pattern. However, the first feature substance is preferably incorporated into the substrate volume with a random distribution. If paper is used as the value document substrate, the first feature substance is preferably added to the paper stock before sheet formation.

In an advantageous development of the invention, a third feature substance which is different from the first feature substance is incorporated into the volume of the value document substrate. As with the first feature substance, the distribution of the third feature substance can form a given structure in the substrate, or be uniform and in particular have a random distribution. This feature substance can also be admixed to the paper stock. The third feature substance can be used for the authenticity check of the value document in addition or as an alternative to the first feature substance.

The marking substances can also be incorporated into the near-surface area of a paper substrate. This is done for example by one of the methods described in the prints EP-A-0 659 935 and DE 101 20 818, in which the particles of the first and/or third marking substance are admixed to a gas stream or a liquid stream and incorporated into a wet paper web. The disclosures of the stated prints are included in the present application in this respect.

The first and/or third feature substances are preferably formed by a luminescent substance or a mixture of luminescent substances. The second feature substance is, in advantageous embodiments, also formed by a luminescent substance or a mixture of luminescent substances. In particular for the first and third feature substances it is preferable to use luminescent substances or mixtures that emit in the infrared spectral range and that in particular have a complex, difficult-to-imitate spectral emission characteristic. Said emission characteristic can be used in particular for distinguishing the luminescent substances from similar luminescent substances. However, it can also be used for producing a coding by the form of the emission spectra or/and excitation spectra of the luminescent substances. “Infrared spectral range” is understood according to the invention to be the wavelength range from 750 nm and more, preferably 800 nm and more. In a preferred embodiment, the second feature substance selected is a luminescent substance whose luminescence can be easily excited and detected with commercially available detectors.

Preferably, at least one of the luminescent feature substances is a luminescent substance based on a host lattice doped with rare earth elements. It is also possible for several or all of the luminescent substances to be formed on the basis of such a doped host lattice. Said luminescent substances can be excited e.g. by irradiating directly into the absorption bands of the rare earth ions. In preferred variants, it is also possible to use absorbent host lattices or so-called sensitizers, which absorb the excitation radiation and transfer it to the rare earth ion, which then emits the luminescence. Obviously, the host lattices and/or the dopants can be different for the different feature substances in order to obtain different excitation and/or emission ranges.

In a preferred embodiment, the host lattice absorbs in the visible spectral range and optionally, in particular in the case of the first or third feature substance, additionally in the near infrared region up to about 1.1 μm. Excitation can then be performed with high effectiveness by light sources, such as halogen lamps, LEDs, lasers, flash lamps or xenon arc lamps, so that only small amounts of the luminescent substance are required. This permits for example an application of the luminescent substance to the value document by usual printing processes. Also, the small amount of substance impedes detection of the used substance by potential forgers. If the host lattice absorbs in the near infrared up to about 1.1 μm, easily detectable emission lines of the rare earth ions can be suppressed, leaving only the emission at larger wavelengths that is more elaborate to detect.

In an alternative preferred embodiment, luminescent substances are used that absorb even in the visible spectral range, preferably over most of the visible spectral range, especially preferably into the near infrared region. Then, too, emissions in these more easily accessible spectral ranges are suppressed.

The host lattice can have for example a perovskite structure or a garnet structure and be doped with a rare earth element emitting in the infrared spectral range, such as praseodymium, neodymium, dysprosium, holmium, erbium, thulium or ytterbium. Further possible embodiments of the host lattice and the dopant are specified in EP-B-0 052 624 or EP-B-0 053 124, whose disclosures are included in the present application in this respect.

According to an advantageous development of the invention, a fourth feature substance which is different from the second feature substance is applied to the value document, in particular printed thereon, in addition to the stated feature substances. The fourth feature substance can in particular be applied to the value document in the form of a coding to further increase the falsification security of the value document.

The fourth feature substance can in particular be formed by a feature substance absorbent in the infrared spectral range, a magnetic or electroconductive feature substance or a substance with an optically variable effect.

Infrared absorbent feature substances that can be used are for example substances that absorb significantly in the spectral range above about 1.2 μm, in particular in the spectral range from about 1.5 μm to 2.2 μm. The infrared absorbers are preferably substantially colorless or have only weak inherent color in the visible spectral range. If the infrared absorbent feature substance does not yet have significant absorption additionally in the near infrared up to a wavelength of about 0.8 μm, it cannot be detected with commercially available silicon-based infrared detectors, so that it forms a security feature that is particularly difficult to find and to imitate.

The codings formed by the second feature substance and/or one of the other feature substances can be any kind of signs or patterns, such as an alphanumeric character string. Preferably, at least one of the codings is a bar code. A bar code is understood here to mean any one- or two-dimensional pattern consisting of stripes or areas with the feature substance or substances (“bars”) and stripes or areas without feature substances located between the bars (“spaces”). As a rule, the bar/space sequence represents a binary number sequence representing any, also encrypted, information about the value document.

The bar code can in particular be invisible to the naked eye and be only detectable by its emission or absorption in a special spectral range after irradiation with a suitable light source. Bar codes are particularly suitable for machine readout and provide an almost fault-free read result, primarily in connection with check digits. Bar codes to be used are for example common formats, such as the 2/5 code, the 2/5 interleaved code, the 128 code or the 39 code, but also special formats used only for the inventive value documents. It is also possible to use two-dimensional bar codes offering a particularly strongly condensed recording and increased redundancy, which makes them less sensitive to production tolerances.

If a plurality of codings are present on the value document, they can be of the same type or of different types. For example, the second marking substance can be printed or sprayed on in the form of a bar code, while the fourth feature substance is printed in the form of an alphanumeric character string.

It is preferably provided that at least one of the codings extends over a predominant part of a surface of the value document, in particular over the substantially total surface of the value document. This makes it possible to obtain a further increase in the falsification security of the value document, since gaps or inserted parts of other, including other authentic, documents manifest themselves as a disturbance in said coding.

For example, in the case of documents of the same kind, such as bank notes of the same denomination, such a coding or a part thereof can be provided with a certain offset from document to document. If the documents are produced in a continuous format, this can be obtained for instance by using a print roll whose circumference is a non-integral multiple of the document size. A row of successive documents can then contain a coding with the same content or the same form, the individual documents at the same time being distinguishable from each other due to the different offset. In sheet-by-sheet printing the same result can be achieved if several printing plates with mutually offset codings or coding parts are used according to the desired repetition rate.

The value document substrate is preferably a printed or unprinted cotton fiber paper, cotton/synthetic fiber paper, a cellulosic paper or a coated, printed or unprinted plastic film. A laminated multilayer substrate can also be used. The material of the substrate is not essential to the invention, provided that it only allows incorporation or application of the particular feature substances required.

The inventive value documents are preferably bank notes, shares, credit cards, badge or identity cards, passports of any type, visas, vouchers, etc.

The second and/or fourth feature substance is advantageously printed on the value document substrate. For this purpose it is possible to use for example a gravure, screen, letterpress, flexographic, ink-jet, digital, transfer or offset printing process. The printing inks used for this purpose can be transparent or contain additional coloring pigments which must not impair detection of the feature substances. In the case of the luminescent substances, they preferably have transparent areas in the excitation range and viewed emission range of the luminescent substances.

In the case of designs in which the value document has a paper substrate, the second feature substance can preferably also be already applied to the moist paper web, in particular sprayed on, in the form of the coding during papermaking. For this purpose, the second feature substance is for example passed onto the paper web surface in a suspension as a laminar jet at low jet pressure at a time when the paper web is still moist but already sufficiently solidified. The low jet pressure prevents the fiber structure of the paper web from changing upon application of the suspension. The place of application can then not be recognized by the naked eye on the finished paper either in reflected light or in transmitted light. Further possibilities and details of the application of the feature substance to a moist paper web are described in the print EP 1 253 241 A2, whose disclosure is included in the present application in this respect.

Obviously, further feature substances can be applied, or incorporated into the substrate, e.g. to further increase the falsification security or to include further user groups.

In a method for checking or processing an above-described value document, the authenticity of the value document is checked and a value recognition of the document carried out by using at least one characteristic property of the first or second feature substance for checking the authenticity of the value document, and the coding formed by the second feature substance for value recognition of the value document. The authenticity of the value document is preferably determined by different user groups using different feature substances. This means that if the user belongs to a first user group, the authenticity of the document is determined using the first feature substance. If the user belongs to a second user group, said user has at its disposal at least one characteristic property of the second feature substance for the authenticity check.

Both user groups carry out the value recognition using the coding formed by the second feature substance, however.

If the value document is provided with a third feature substance, the check or processing by a user of the first user group can be done by using at least one characteristic property of the first and/or third feature substance for checking the authenticity of the value document. For example, some of the users from the first user group can use the first feature substance for the authenticity check, and others the third feature substance.

In a preferred embodiment of the invention, the presence of a first and/or third feature substance indicates the series or the particular existing upgrade e.g. of a bank-note issue. For example, only the first feature substance can be present in an originally issued currency, and the first and third feature substances in the upgrade of the currency. After a certain transition period it is conceivable to use only the third feature substance.

If the second feature substance is formed by a luminescent substance, the value recognition is preferably done by both user groups by irradiating the second feature substance with radiation from its excitation range, determining the emission at at least one wavelength from the emission range of the second feature substance, and carrying out the value recognition on the basis of the measured emission. The second user group can also use the emission behavior for the authenticity check of the document.

Preferably, the second feature substance is thereby irradiated with visible and/or infrared radiation and its emission determined in the infrared spectral range. The irradiation is expediently effected with a light-emitting diode or laser diode.

The described methods involve the advantage that both user groups can carry out not only the authenticity check but also a value recognition on the document without any great additional effort. A further advantage is that the users of the first and second user groups can use, for evaluation, different combinations of the feature substances or the coding formed thereby. Therefore, an analysis of an apparatus for authenticity detection of the second user group, for example, gives no indication of the procedure in the authenticity check of the first user group, since said detection device does not interrogate any of the properties of the first or third feature substance.

Further embodiments and advantages of the invention will be explained hereinafter with reference to the figures. For clarity's sake, the representation in the figures is not true to scale or to proportion.

The figures are described as follows:

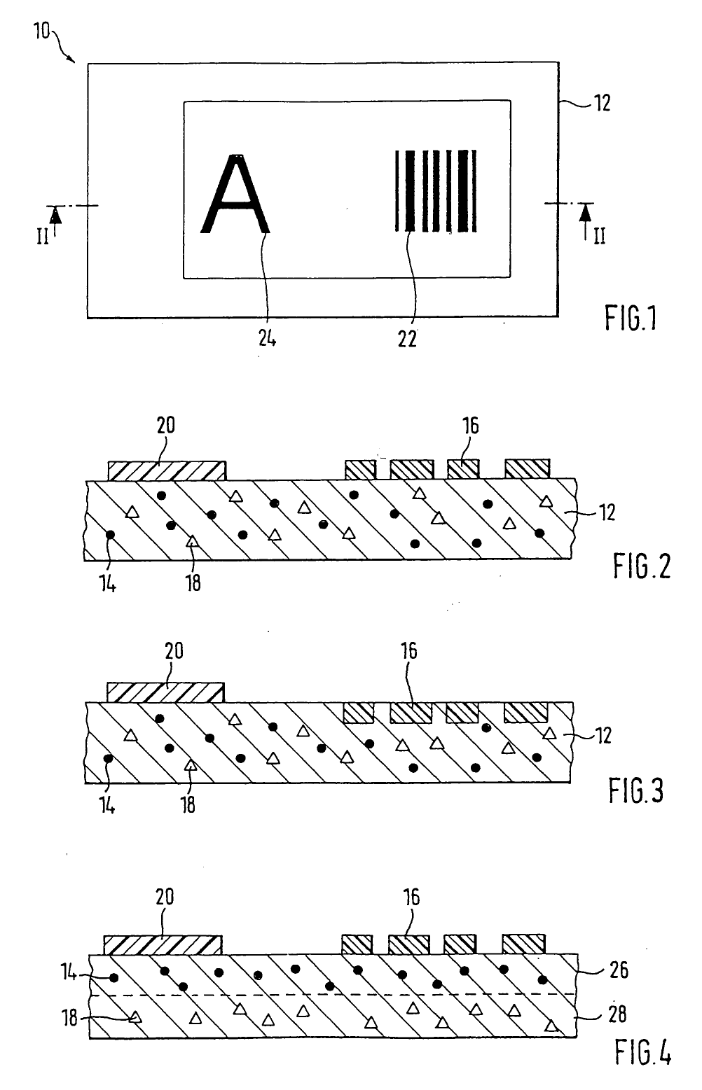

FIG. 1 a schematic representation of a bank note according to one embodiment of the invention,

FIG. 2 a section through the bank note of FIG. 1 along the line II-II, and

FIGS. 3 and 4 sections of a bank note according to further embodiments of the invention.

The invention will now be explained by the example of a bank note. First, FIGS. 1 and 2 show schematic representations of a bank note 10 which is equipped with four different feature substances and permits a check of authenticity and a value recognition by different user groups. FIG. 1 shows the bank note 10 in a plan view and FIG. 2 a cross section along the line II-II of FIG. 1.

As seen best in FIG. 2, two of the feature substances, namely the first feature substance 14 and the third feature substance 18, are distributed in the form of particles uniformly within the volume of the paper substrate 12 of the bank note 10. The particles of the first and third feature substances 14, 18 can be added to the paper pulp or fibrous pulp before sheet formation or be incorporated into the fibrous matrix only after sheet formation.

In this embodiment, the first feature substance 14 is formed by a luminescent substance based on a rare earth metal doped host lattice and emitting after excitation in the infrared spectral range in the wavelength range around 1.5 μm. The third feature substance 18 is formed by a mixture of different luminescent substances which, after excitation, emits radiation with a complex and difficult-to-imitate spectral distribution.

A second feature substance 16 is admixed to a printing ink and printed together therewith in the form of a coding 22 on the front of the bank note 10. In the embodiment, the coding 22 is a bar code in which the denomination and the currency of the bank note 10 is stored in encrypted form.

The second feature substance 16 is likewise formed by a luminescent substance which is selected specifically so that its luminescence can be easily excited and detected with commercially available detectors.

The authenticity check and the value recognition can now be carried out by two different user groups using different combinations of the three feature substances 14, 16 and 18 or the coding 22. The bank note 10 of the embodiment is designed for a first user group with high security requirements and a second user group with comparatively low security requirements.

The second user group can involve for example simple machines taking bank notes in parking lots, or vending machines. For this use it is particularly expedient to employ inexpensive detection apparatuses for the authenticity check and value recognition.

A user of the second user group checks the authenticity of a bank note 10 by irradiating the bank note with light from the excitation range of the second feature substance 16 and detecting a corresponding luminescence signal. If a correct luminescence signal is received, the bank note is rated as authentic by the user. The presence of the correct luminescence signal suffices, no spatially resolved evaluation or analysis of the emission spectrum being required for the authenticity check. Due to the choice of the luminescent substance 16 this detection can be effected very simply and with commercially available, inexpensive detectors. If the bank note is recognized as authentic, its value can be taken from the bar code 22 if the coding scheme is known. The authenticity check and the value recognition can of course also be carried out in one step.

The first user group with its higher security requirements can comprise for example banks, where the authenticity of the bank notes is checked with high-quality and elaborate detectors. The first feature substance 14 with its difficult-to-detect infrared emission at 1.5 μm serves as an authenticity mark for this user group. Alternatively or additionally, the third feature substance 18 with its complex spectral emission can be used for the authenticity check. The authenticity check is preferably based not only on detection of the correct luminescence emission, but also on an in-depth analysis of the emission spectrum, whereby half-widths and/or luminescence peak intervals and/or decay times, etc., are rated.

The value recognition of the bank note is carried out both by a user of the first user group and by the users of the second user group with the help of the luminescent second feature substance 16. The high-quality authenticity check by the first or third feature substance 14 or 18 at the same time guarantees the first user group the correctness of the value of the bank note read with the help of the luminescent substance 16.

In the concrete embodiment of FIGS. 1 and 2, a fourth feature substance 20 is printed, in addition to the stated feature substances, on the bank note 10 in the form of a further coding 24. The further coding 24 can generally be likewise formed as a bar code or, as indicated in FIG. 1, be an alphanumeric character string. In the embodiment, the fourth feature substance is formed by an infrared absorber which absorbs in the range of around 1.5 μm but is transparent in the visible spectral range and in the near infrared up to about 0.8 μm. The printed coding 24 can thus not be recognized by the naked eye or by commercially available silicon-based infrared detectors.

FIG. 3 shows a further embodiment in which the second feature substance 16 is already sprayed onto the still moist paper web in the form of the bar code 22 during papermaking. In the finished bank note the coding 22 is then located below the uppermost size layer of the paper substrate 12.

The fourth feature substance 20 is formed in this bank note by optically variable pigments which are admixed to a printing ink and printed therewith on the bank note substrate 12. The fourth feature substance can also be a further luminescent substance, however, which is admixed to a optically variable ink. The coding 24 then conveys to the viewer different color effects at different viewing angles.

In the embodiment shown in FIG. 4, the paper substrate 12 has two paper layers 26 and 28 that are initially produced separately and interconnected in the course of papermaking. The first feature substance 14 is incorporated into the paper layer 26, and the third feature substance 18 into the paper layer 28. It is also possible for one of the paper layers, for example the layer 26, to contain both feature substances, while the other paper layer is not provided with a feature substance.

1. A value document, comprising a value document substrate and at least two different feature substances for checking the value document, wherein the first feature substance is incorporated into the volume of the substrate of the value document, and the second feature substance is provided on to the value document substrate in the form of a coding.

2. The value document according to claim 1, wherein the first feature substance is distributed substantially uniformly within the volume of the value document substrate.

3. The value document according to claim 1, wherein a third feature substance different from the first feature substance is incorporated into the volume of the substrate of the value document.

4. The value document according to claim 3, wherein the third feature substance is distributed substantially uniformly within the volume of the value document substrate.

5. The value document according to claim 1, wherein at least one of the first or third feature substance is formed by at least one of a luminescent substance and a mixture of luminescent substances.

6. The value document according to claim 1, wherein the second feature substance is formed by a luminescent substance or a mixture of luminescent substances.

7. The value document according to claim 1, wherein at least one of the feature substances is formed on the basis of a host lattice doped with rare earth elements.

8. The value document according to claim 1, wherein a fourth feature substance is applied to the value document, which is different from the second feature substance.

9. The value document according to claim 8, wherein the fourth feature substance is formed by a feature substance absorbent in the infrared spectral range.

10. The value document according to claim 9, wherein the fourth feature substance is substantially colorless or has only weak inherent color in the visible spectral range.

11. The value document according to claim 8, wherein the fourth feature substance is formed by a substance selected from the group consisting of a magnetic substance, an electroconductive substance and a substance with an optically variable effect.

12. The value document according to claim 8, wherein the fourth feature substance is printed on the value document in the form of a coding.

13. The value document according to claim 1, wherein at least one coding extends over a predominant part of a surface of the value document.

14. The value document according to claim 1, wherein at least one coding is a bar code.

15. The value document according to claim 1, wherein at least one coding represents information about the value document, the information being present in one of encrypted and unencrypted form.

16. The value document according to claim 1, wherein the value document substrate comprises a printed or unprinted cotton fiber paper.

17. The value document according to claim 1, wherein the value document substrate comprises a plastic film that is one of coated, printed and unprinted.

18. The value document according to claim 1, wherein the second feature substance is a printing on the value document substrate.

19. The value document according to claim 1, wherein the substrate is paper having the form of a moist paper web during its production, and the second feature substance is applied to the moist paper web, in particular sprayed on, in the form of the coding during papermaking.

20. A method for producing a value document according to claim 1, comprising the steps: the first feature substance is incorporated into the volume of the value document substrate, and the second feature substance is applied to the value document substrate in the form of a coding.

21. The production method according to claim 20, wherein the second feature substance is printed on the value document substrate.

22. The production method according to claim 20, wherein the value document substrate is formed by a printed or unprinted cotton paper having the form of a moist paper web during its production, and the second feature substance is sprayed onto the moist paper web during papermaking.

23. The production method according to claim 20, wherein a third feature substance is incorporated into the value document substrate.

24. The production method according to claim 20, wherein a fourth feature substance is applied to the value document substrate.

25. A method for checking or processing a value document according to claim 1, comprising the steps: checking the authenticity of the value document and carrying out a value recognition of the document by using at least one characteristic property of at least one of the first and second feature substance for checking the authenticity of the value document, and the coding formed by the second feature substance for at least one of value recognition and currency recognition of the value document.

26. The method according to claim 25, wherein at least one characteristic property of the first feature substance is used for checking the authenticity of the value document by a user of a first user group.

27. The method according to claim 25, wherein at least one characteristic property of the second feature substance is used for checking the authenticity of the value document by a user of a second user group.

28. The method according to claim 25, wherein at least one characteristic property of at least one of the first and third feature substance is used for checking the authenticity of the value document.

29. The method according to claim 25, wherein the second feature substance is formed by a luminescent substance, and the second feature substance is irradiated with radiation from its excitation range, the emission is determined at at least one wavelength from the emission range of the second feature substance, and the check of at least one of authenticity and the value recognition is carried out on the basis of the determined emission.

30. The method according to claim 29, wherein the second feature substance is irradiated with at least one of visible and infrared radiation, and its emission is determined in the infrared spectral range.

31. The method according to claim 29, wherein the irradiation is performed with a light-emitting diode or laser diode.

32. The method according to claim 8, wherein the fourth feature substance is printed on the value document.

33. The value document according to claim 9, wherein the infrared spectral range is selected from the group consisting of above about 1.2 μm; and from about 1.5 μm to 2.2 μm.

34. The value document according to claim 10, wherein the fourth feature substance does not have significant absorption even in the near infrared up to a wavelength of about 0.8 μm.

35. The value document according to claim 13, wherein said at least one coding extends over a substantially total surface of the value document.

36. The value document according to claim 14, wherein said second marking substance forms said bar code.

37. The production method according to claim 24, wherein the fourth feature substance is applied to the value document by printing thereon.
